(19) United States
(12) Patent Application Publication
(10) Pub. No.: US 2020/0015203 A1
(43) Pub. Date: Jan. 9, 2020

(54) METHOD AND APPARATUS FOR NUMEROLOGY CONFIGURATION IN NON-COHERENT JOINT TRANSMISSION

(71) Applicant: Intel IP Corporation, Santa Clara, CA (US)

(72) Inventors: Yushu Zhang, Beijing (CN); Gang Xiong, Portland, OR (US); Honglei Miao, Munich BY (DE); Wook Bong Lee, San Jose, CA (US); Alexei Davydov, Nizhny Novgorod NIZ (RU)

(21) Appl. No.: 16/483,393

(22) PCT Filed: Apr. 20, 2018
(86) PCT No.: PCT/CN2018/083870

§ 371 Date: Aug. 2, 2019

(30) Foreign Application Priority Data
Apr. 21, 2017 (CN) PCT/CN2017/081406

(51) Int. Cl. H04W 72/04; H04W 76/27; H04L 1/00; H04L 5/00; H04B 7/024

(52) U.S. Cl. CPC H04W 72/042; H04W 72/0426; H04B 7/024; H04L 1/0025; H04L 5/0035; H04W 76/27

(57) ABSTRACT

Provided herein are method and apparatus for numerology configuration in non-coherent joint transmission. The disclosure provides an apparatus for a user equipment (UE), comprising circuitry configured to: determine one or more numerologies defined for at least one of different codewords, different layers, and different links for a non-coherent joint transmission (NCJT) to the UE, the NCJT comprising a first transmission from a first access node and a second transmission from a second access node; and process the NCJT according to the determined one or more numerologies. Also provided is a configuration of one or more transmission schemes for at least one of different codewords, different layers, and different links for a NCJT to the UE. Some embodiments allow for uplink NCJT with one or more numerologies defined for at least one of different codewords, different layers, and different links.

### CROSS REFERENCES TO RELATED APPLICATIONS

This application claims priority to International Application No. PCT/CN2017/081406 filed on Apr. 21, 2017, entitled “NUMEROLOGY CONFIGURATION IN NON-COHERENT JOINT TRANSMISSION”, which is incorporated by reference herein in its entirety for all purposes.

### TECHNICAL FIELD

Embodiments of the present disclosure generally relate to apparatus and method for wireless communications, and in particular to numerology configuration in non-coherent joint transmission (NCJT).

### BACKGROUND ART

Wireless communication systems are widely deployed to provide various types of communications. In some cases, a user equipment (UE) may communicate with more than one access node using coordinated multi-point (CoMP) operations to improve a user's experience. As a CoMP transmission, NCJT has a lower requirement on backhaul speed between the access nodes, and may allow transmissions from each access node independently.

### SUMMARY

An embodiment of the disclosure provides an apparatus for a user equipment (UE), the apparatus comprising circuitry configured to: determine one or more numerologies defined for at least one of different codewords, different layers, and different links for a non-coherent joint transmission (NCJT) to the UE, the NCJT comprising a first transmission from a first access point and a second transmission from a second access point; and process the NCJT according to the determined one or more numerologies.

### BRIEF DESCRIPTION OF THE DRAWINGS

Embodiments of the disclosure will be illustrated, by way of example and not limitation, in the figures of the accompanying drawings in which like reference numerals refer to similar elements.

FIG. 1 shows an architecture of a system of a network in accordance with some embodiments of the disclosure.

FIG. 2 is a flow chart showing operations for numerology configuration in NCJT in accordance with some embodiments of the disclosure.

FIG. 3 is a flow chart showing operations for numerology configuration in NCJT in accordance with some embodiments of the disclosure.

FIG. 4 is a flow chart showing operations for numerology configuration in NCJT in accordance with some embodiments of the disclosure.

FIG. 5 is a flow chart showing operations for numerology configuration in NCJT in accordance with some embodiments of the disclosure.

FIG. 6 is a flow chart showing operations for numerology configuration in NCJT in accordance with some embodiments of the disclosure.

FIG. 7 illustrates example components of a device in accordance with some embodiments of the disclosure.

FIG. 8 illustrates example interfaces of baseband circuitry in accordance with some embodiments.

FIG. 9 is a block diagram illustrating components, according to some example embodiments, able to read instructions from a machine-readable or computer-readable medium and perform any one or more of the methodologies discussed herein.

### DETAILED DESCRIPTION OF EMBODIMENTS

Various aspects of the illustrative embodiments will be described using terms commonly employed by those skilled in the art to convey the substance of their work to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in an embodiment” is used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

Explosive wireless traffic growth leads to an urgent need of new spectrum resource to improve capacity of a wireless communication system. In fifth generation (5G) communication technology, high bands, for example, the bands above 6 GHz, have attracted growing attention. There is relatively abundant spectrum resource in high bands. However, significant transmission path loss may occur in high bands due to short wavelength. In this case, NCJT may be used to compensate for the path loss by increasing layers from more than one access node. A UE may have more than one antenna panel to communicate with each of the more than one access node, and thus Multi Input and Multi Output (MIMO), in broad sense, may be used in the embodiments of the present disclosure.

The present disclosure provides approaches to perform numerology configuration for at least one of different codewords, different layers, and different links for a NCJT.

In accordance with some embodiments of the disclosure, the term “numerology” is used in consistent with the third Generation Partnership Project (3GPP) TR 38.802 (V2.0.0, 2017-03). For example, a numerology may include at least one of subcarrier space, cyclic prefix length, symbol length. In some embodiments of the disclosure, numerology may include one or more other parameters.

In accordance with some embodiments of the disclosure, the term “link” is used in consistent with the 3GPP TR 38.802 (V2.0.0, 2017-03). That is, a link may refer to a group of layers.

In accordance with some embodiments of the disclosure, each access node (e.g. next Generation NodeB (gNB)) may communicate with a UE using a different layer. In accordance with some embodiments of the disclosure, each access node may utilize multiple layers to transmit a codeword.

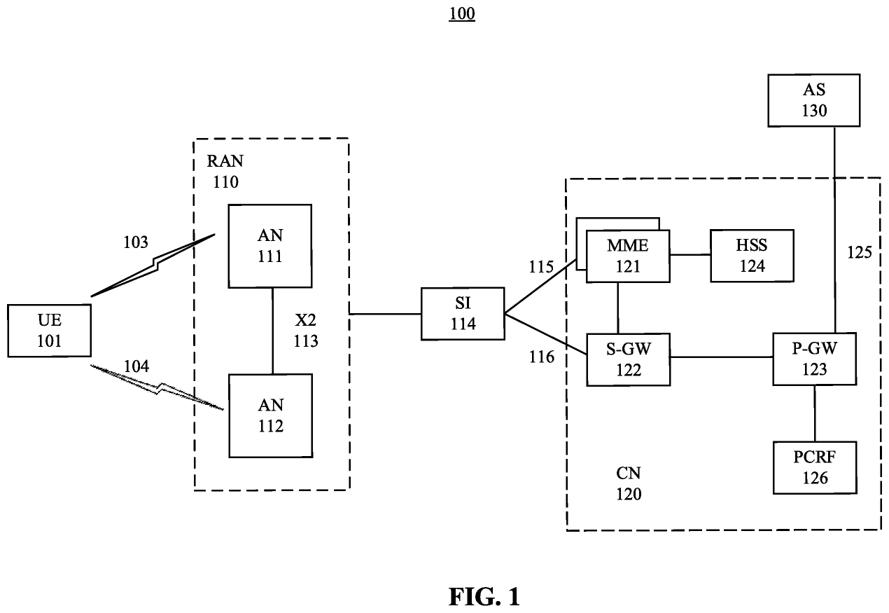

FIG. 1 illustrates an architecture of a system 100 of a network in accordance with some embodiments. The system 100 is shown to include a user equipment (UE) 101. The UE 101 is illustrated as a smartphone (e.g., a handheld touchscreen mobile computing device connectable to one or more cellular networks). However, it may also include any mobile or non-mobile computing device, such as a personal data assistant (PDA), a tablet, a pager, a laptop computer, a desktop computer, a wireless handset, or any computing device including a wireless communications interface.

The UE 101 may be configured to connect, e.g., communicatively couple, with a radio access network (RAN) 110, which may be, for example, an Evolved Universal Mobile Telecommunications System (UMTS) Terrestrial Radio Access Network (E-UTRAN), a NextGen RAN (NG RAN), or some other type of RAN. The UE 101 may utilize connections 103 and 104 through two antenna panels to enable communicative coupling with the RAN 110. The UE 101 may operate in consistent with cellular communications protocols, such as a Global System for Mobile Communications (GSM) protocol, a Code-Division Multiple Access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

The RAN 110 may include one or more access nodes (ANs) that enable the connections 103 and 104. These access nodes may be referred to as base stations (BSs), NodeBs, evolved NodeBs (eNBs), next Generation NodeBs (gNBs), and so forth, and may include ground stations (e.g., terrestrial access points) or satellite stations providing coverage within a geographic area (e.g., a cell). As shown in FIG. 1, for example, the RAN 110 includes AN 111 and AN 112. The AN 111 and AN 112 may communicate with one another via an X2 interface 113. The AN 111 and AN 112 may be macro ANs which may provide lager coverage. Alternatively, they may be femtocell ANs or picocell ANs, which may provide smaller coverage areas, smaller user capacity, or higher bandwidth compared to a macro AN. For example, one or both of the AN 111 and AN 112 may be a low power (LP) AN. In an embodiment, the AN 111 and AN 112 may be the same type of AN. In another embodiment, they are different types of ANs.

Any of the ANs 111 and 112 may terminate the air interface protocol and may be the first point of contact for the UE 101. In some embodiments, any of the ANs 111 and 112 may fulfill various logical functions for the RAN 110 including, but not limited to, radio network controller (RNC) functions such as radio bearer management, uplink and downlink dynamic radio resource management and data packet scheduling, and mobility management.

In accordance with some embodiments, the UE 101 may be configured to communicate using Orthogonal Frequency-Division Multiplexing (OFDM) communication signals with any of the ANs 111 and 112 or with other UEs over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and Proximity-Based Service (ProSe) or sidelink communications), although the scope of the embodiments is not limited in this respect. The OFDM signals can include a plurality of orthogonal subcarriers.

In some embodiments, a downlink resource grid may be used for downlink transmissions from any of the ANs 111 and 112 to the UE 101, while uplink transmissions may utilize similar techniques. The grid may be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 101. The physical downlink control channel (PDCCH) may carry information about the transport format and resource allocations related to the PDSCH channel, among other things. It may also inform the UE 101 about the transport format, resource allocation, and HARQ (Hybrid Automatic Repeat Request) information related to the uplink shared channel. Typically, downlink scheduling (assigning control and shared channel resource blocks to the UE 101 within a cell) may be performed at any of the ANs 111 and 112 based on channel quality information fed back from the UE 101. The downlink resource assignment information may be sent on the PDCCH used for (e.g., assigned to) the UE 101.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There may be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced control channel elements (ECCEs). Similar to above, each ECCE may correspond to nine sets of four physical resource elements known as an enhanced resource element groups (EREGs). An ECCE may have other numbers of EREGs in some situations.

The RAN 110 is shown to be communicatively coupled to a core network (CN) 120 via an S1 interface 114. In some embodiments, the CN 120 may be an evolved packet core (EPC) network, a NextGen Packet Core (NPC) network, or some other type of CN. In an embodiment, the S1 interface 114 is split into two parts: the S1-mobility management entity (MME) interface 115, which is a signaling interface between the ANs 111 and 112 and MMEs 121; and the S1-U interface 116, which carries traffic data between the ANs 111 and 112 and a serving gateway (S-GW) 122.

In an embodiment, the CN 120 may comprise the MMEs 121, the S-GW 122, a Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-AN handovers and also may provide an anchor for inter-3GPP mobility. Other responsibilities may include lawful intercept, charging, and some policy enforcement.

The P-GW 123 may terminate a SGi interface toward a PDN. The P-GW 123 may route data packets between the CN 120 and external networks such as a network including an application server (AS) 130 (alternatively referred to as application function (AF)) via an Internet Protocol (IP) interface 125. Generally, the application server 130 may be an element offering applications that use IP bearer resources with the core network (e.g., UMTS Packet Services (PS) domain, LTE PS data services, etc.). In an embodiment, the P-GW 123 is communicatively coupled to an application server 130 via an IP communications interface. The application server 130 may also be configured to support one or more communication services (e.g., Voice-over-Internet Protocol (VoIP) sessions, PTT sessions, group communication sessions, social networking services, etc.) for the UE 101 via the CN 120.

The P-GW 123 may further be responsible for policy enforcement and charging data collection. Policy and Charging Rules Function (PCRF) 126 is a policy and charging control element of the CN 120. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 126 may be communicatively coupled to the application server 130 via the P-GW 123. The application server 130 may signal the PCRF 126 to indicate a new service flow and select the appropriate Quality of Service (QoS) and charging parameters. The PCRF 126 may provision this rule into a Policy and Charging Enforcement Function (PCEF) (not shown) with an appropriate traffic flow template (TFT) and QoS class of identifier (QCI), which commences the QoS and charging as specified by the application server 130.

The quantity of devices and/or networks illustrated in FIG. 1 is provided for explanatory purposes only. In practice, there may be additional devices and/or networks, fewer devices and/or networks, different devices and/or networks, or differently arranged devices and/or networks than illustrated in FIG. 1. Alternatively or additionally, one or more of the devices of system 100 may perform one or more functions described as being performed by another one or more of the devices of system 100. Furthermore, while “direct” connections are shown in FIG. 1, these connections should be interpreted as logical communication pathways, and in practice, one or more intervening devices (e.g., routers, gateways, modems, switches, hubs, etc.) may be present.

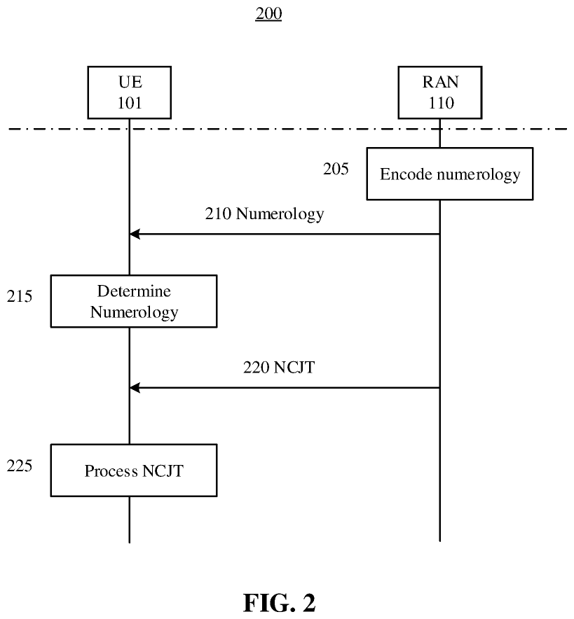

FIG. 2 is a flow chart 200 showing operations for numerology configuration in NCJT in accordance with some embodiments of the disclosure. The operations of FIG. 2 may be used for a UE (e.g. UE 101) to process a NCJT transmitted from a RAN (e.g. RAN 110) according to numerology configuration for the NCJT.

At 205, the RAN 110 may configure (e.g., determine, encode and the like) one or more numerologies for the NCJT to the UE 101. In an embodiment, the RAN 110 may encode the one or more numerologies in Downlink Control Information (DCI). In another embodiment, the RAN 110 may encode the one or more numerologies in higher layer signaling. In some embodiments, the higher layer signaling may include radio resource control (RRC) signaling. At 210, the RAN 110 may transmit the one or more numerologies to the UE 101 in the DCI or higher layer signaling. In some embodiments, the RAN 110 may encode and transmit the one of more numerologies as indicators of the one or more numerologies in the DCI or higher layer signaling. At 215, the UE 101 may determine the numerology from the received DCI or higher layer signaling. At 220, the RAN 110 may transmit the NCJT to the UE 101. At 225, the UE 101 may process the NCJT according to the determined one or more numerologies. The configuration of the one or more numerologies may be based on factors including but not limited to spectrum efficiency, anti-frequency-shift capacity and the like.

In some embodiments of the disclosure, the NCJT may include a number of transmissions from a number of ANs of the RAN 110. In an embodiment, the NCJT may include a first transmission from a first AN (e.g. AN 111) and a second transmission from a second AN (e.g. AN 112).

In some embodiments, the RAN 110 may configure the one or more numerologies for at least one of different codewords, different layers, and different links for the NCJT. In some embodiments, the RAN 110 may configure a single numerology for all codewords, layers, and/or links. In other words, the same numerology is configured for all codewords, layers, and/or links for the NCJT. In some embodiments, the RAN 110 may configure more than one numerology for at least one of different codewords, different layers, and different links. In other words, different numerologies are configured for different codewords, different layers, or different links for the NCJT. Also, different numerologies may be configured for a combination of different codewords, different layers, and different links.

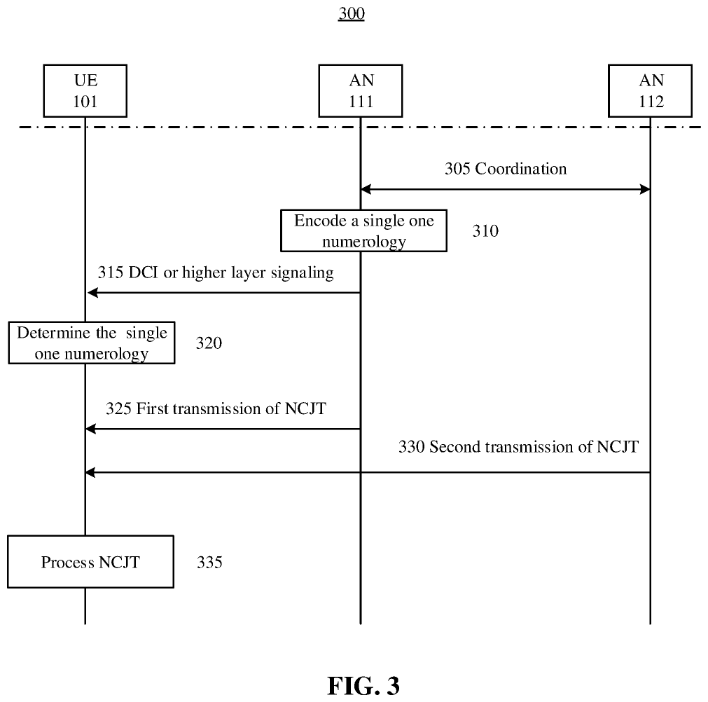

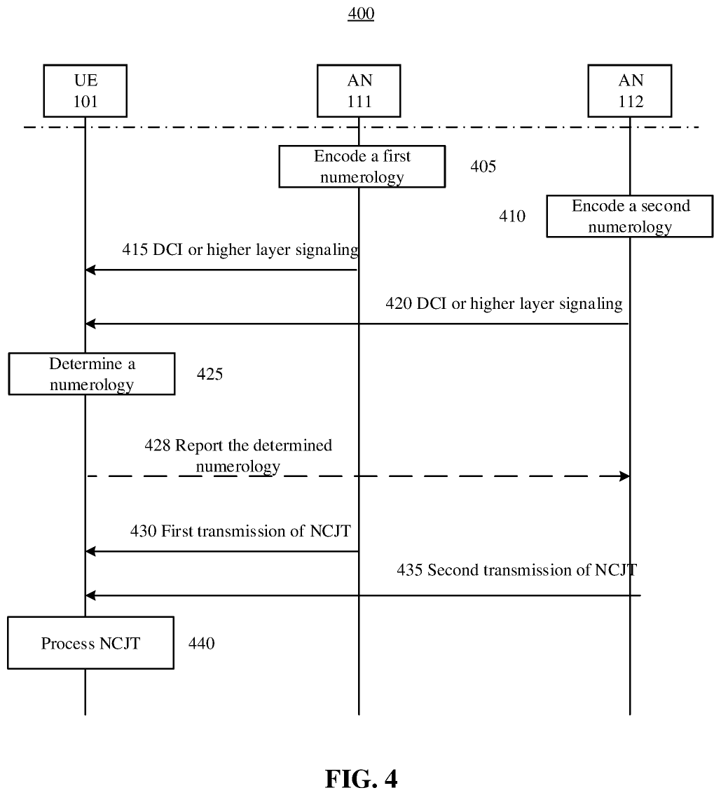

FIG. 3 is a flow chart 300 showing operations for numerology configuration in NCJT in accordance with some embodiments of the disclosure. FIG. 4 is a flow chart 400 showing operations for numerology configuration in NCJT in accordance with some embodiments of the disclosure. The operations of FIG. 3 and FIG. 4 may be used for a UE (e.g. UE 101) to process a NCJT transmitted from a number of ANs (e.g. AN 111 and AN 112) of a RAN (e.g. RAN 110) according to numerology configuration for the NCJT. In the embodiments shown in FIG. 3 and FIG. 4, a single numerology is configured for all codewords, layers, and links for the UE 101.

Turning to FIG. 3. At 305, the AN 111 and AN 112 may coordinate with one another to decide a single numerology for the NCJT to the UE 101. At 310, the AN 111 may determine the numerology based on the coordination. In an embodiment, the AN 111 may operate as a serving AN for the UE 101, and the AN 112 may operate as an assistant AN for the UE 101. In some embodiments, the numerology and/or numerology indicators may be encoded in DCI or higher layer signaling.

At 315, the AN 111, for example, may transmit the DCI or higher layer signaling to the UE 101. At 320, the UE 101 may decode the DCI or higher layer signaling received from the AN 111 to determine the numerology for the NCJT. At 325 and 330, UE 101 may receive a first transmission and a second transmission of the NCJT from the AN 111 and the AN 112 respectively. The first transmission and the second transmission are encoded by the AN 111 and the AN 112 respectively with the same numerology. At 335, the UE 101 may process the NCJT from the AN 111 and the AN 112 based on the numerology determined at 320.

Though FIG. 3 shows configuring the numerology at the serving AN, indeed any of the serving AN and the assistant AN for the UE 101 may configure the numerology based on their coordination. In other words, it is also possible that the assistant AN 112 configures the numerology based on the coordination. In this case the operations of 310 and 315 may be moved to the AN 112 and the flow chart 300 may remain the same otherwise.

FIG. 4 is also directed to configuration of a single numerology for all codewords, layers, and links for the NCJT to the UE 101. Different from FIG. 3, in the flowchart 400 of FIG. 4 both the AN 111 and the AN 112 may configure a numerology for the first transmission and the second transmission of the NCJT independently. As shown at 405, the AN 111 may encode a first numerology for the first transmission in the DCI or higher layer signaling of the AN 111; and as shown at 410, the AN 112 may encode a second numerology for the second transmission in the DCI or higher layer signaling of the AN 112.

At 415 and 420, the AN 111 and AN 112 may transmit respective DCI or higher layer signaling to the UE 101. After receiving the DCI or higher layer signaling from the AN 111 and AN 112, the UE 101 may decode the received DCI or higher layer signaling to determine a numerology at 425.

As the AN 111 and AN 112 perform configuration of numerology independently, the numerology decoded from the DCI or higher layer signaling of the AN 111 may be different from that decoded from the DCI or higher layer signaling of the AN 112. In this case, the UE 101 may determine the numerology, which is used to decode the NCJT, as the numerology decoded from the DCI or higher layer signaling of the AN 111, for example, which is operating as a serving AN. At 428, the UE 101 may report the determined numerology, that is, the numerology configured by the AN 111, to the AN 112, which is, for example, operating as an assistant AN. As such, the AN 111, AN 112, and UE 101 may process the NCJT with the same numerology.

In case of the numerology decoded from the DCI or higher layer signaling of the AN 111 being same with that decoded from the DCI or higher layer signaling of the AN 112, the operation at 428 may be omitted.

At 430 and 435, the UE 101 may receive the first transmission and the second transmission of the NCJT from the AN 111 and the AN 112. At 440, the UE 101 may process the NCJT based on the single numerology determined by the UE 101.

In some embodiments, the AN 111 and/or AN 112 may coordinate with a third AN about the numerology for the UE 101 during handover of the UE 101 from one or both of the AN 111 and the AN 112 to the third AN.

Configuration of a single one numerology for all codewords, layers, and links has been described above, and configuration of different numerologies for at least one of different codewords, different layers, or different links will be detailed below.

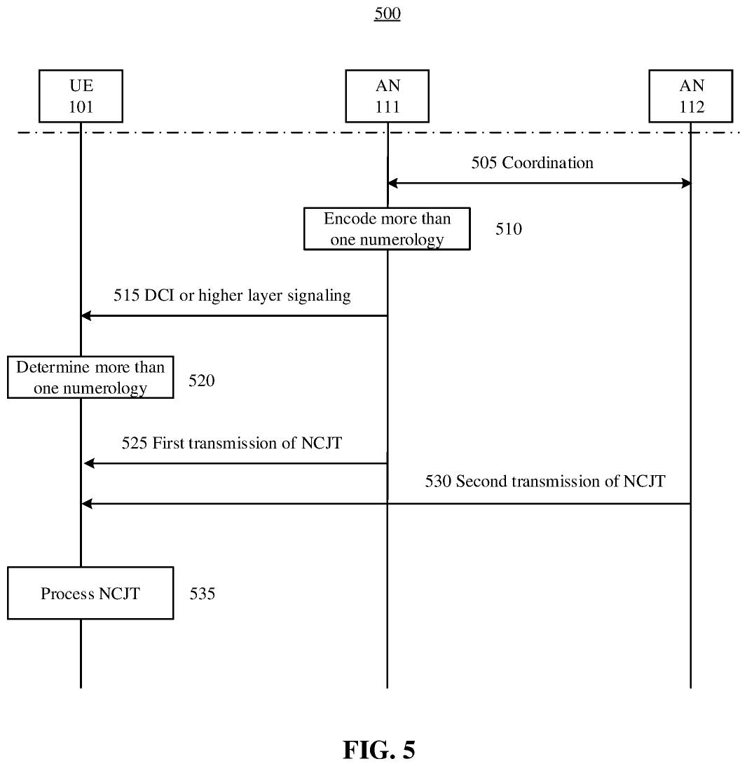

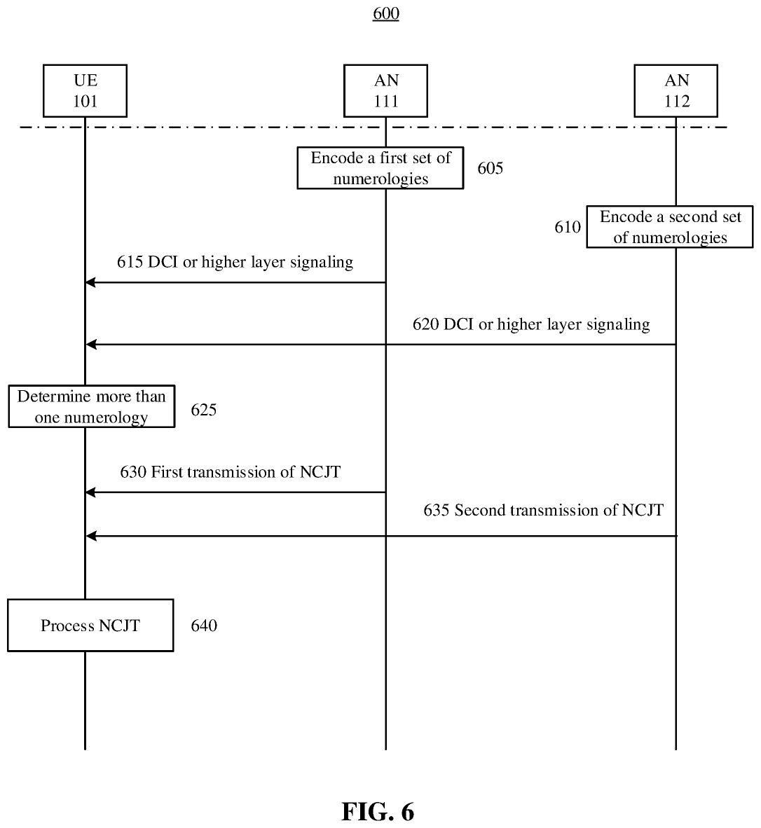

FIG. 5 is a flow chart 500 showing operations for numerology configuration in NCJT in accordance with some embodiments of the disclosure. FIG. 6 is a flow chart 600 showing operations for numerology configuration in NCJT in accordance with some embodiments of the disclosure. The operations of FIG. 5 and FIG. 6 may be used for a UE (e.g. UE 101) to process a NCJT transmitted from a number of ANs (e.g. AN 111 and AN 112) of a RAN (e.g. RAN 110) according to more than one numerology, rather than a single numerology, for at least one of different codewords, different layers, or different links. In other words, in the embodiments of FIG. 5 and FIG. 6, different numerologies may be configured for different codewords, different layers, or different links, or a combination thereof.

Comparing FIG. 5 against FIG. 3 and FIG. 4, the AN 111 may configure more than one numerology (i.e., different numerologies) for different codewords, different layers, or different links, or a combination thereof, and then the UE 101 may process the NCJT from the AN 111 and the AN 112 based on the more than one numerology.

At 505, the AN 111 and AN 112 may coordinate with one another to decide the numerologies for the NCJT to the UE 101. At 510, the AN 111 may determine and encode the numerologies based on the coordination. In other embodiments, the AN 112 may determine and encode the numerologies based on the coordination. In some embodiments, the numerologies and numerology indicators may be encoded in DCI or higher layer signaling.

In some embodiments of FIG. 5, the numerologies encoded by the AN 111 may be used by the UE 101 to decode both a first transmission from AN 111 and a second transmission from AN 112. In other words, after the coordination between the AN 111 and the AN 112, the AN 111 may be aware of the numerologies for a second transmission from the AN 112 as well as the numerologies for the first transmission from itself. In some embodiments, one or both of the first transmission and the second transmission may use more than one codeword, more than one layer, and/or more than one link. In some embodiments, the AN 111 may determine a first set of numerologies for different codewords, different layers, and/or different links for the first transmission from the AN 111 to the UE 101, and the AN 112 may determine a second set of numerologies for different codewords, different layers, and/or different links for the second transmission from the AN 112 to the UE 101. In an embodiment, the first set of numerologies may be the same with the second set of numerologies. In another embodiment, the first set of numerologies may be different from the second set of numerologies.

At 515, the AN 111, for example, may transmit the DCI or higher layer signaling to the UE 101. At 520, the UE 101 may decode the DCI or higher layer signaling received from the AN 111 to determine the first set of numerologies and second set of numerologies. At 525 and 530, the UE 101 may receive the first transmission and the second transmission of the NCJT from the AN 111 and the AN 112 respectively. The first transmission and the second transmission are encoded by the AN 111 and the AN 112 with the respective first set of numerologies and second set of numerologies respectively. At 535, the UE 101 may process the first transmission from the AN 111 and the second transmission from the AN 112 based on the determined respective sets of numerologies.

FIG. 6 is also directed to configuration of more than one numerology for different codewords, different layers or different links, or a combination thereof for the NCJT to the UE 101. Comparing FIG. 6 against FIG. 5, the AN 111 and AN 112 may determine and encode numerologies for the first transmission and the second transmission of the NCJT independently via respective DCI or higher layer signaling. As shown at 605, the AN 111 may encode a first set of numerologies for the first transmission in the DCI or higher layer signaling of the AN 111; and as shown at 610, the AN 112 may encode a second set of numerologies for the second transmission in the DCI or higher layer signaling of the AN 112.

At 615 and 620, the AN 111 and AN 112 may transmit respective DCI or higher layer signaling to the UE 101. After receiving the DCI or higher layer signaling from the AN 111 and AN 112, the UE 101 may, at 625, decode the received DCI or higher layer signaling to determine numerologies.

As the AN 111 and AN 112 perform configuration of numerology independently, the numerologies decoded from the DCI or higher layer signaling of the AN 111 may be the same with or different from those decoded from the DCI or higher layer signaling of the AN 112. In either case, the UE 101 may determine respective numerologies encoded by the AN 111 and the AN 112 respectively.

At 630 and 635, the UE 101 may receive the first transmission and the second transmission of the NCJT from the AN 111 and the AN 112. At 640, the UE 101 may process the first transmission and second transmission of the NCJT based on the determined numerologies from the DCI or higher layer signaling of the AN 111 and the determined numerologies from the DCI or higher layer signaling of the AN 112 respectively.

In some embodiments of configuration of different numerologies for different codewords, different layers, and/or different links (e.g., the embodiments shown in FIG. 5 and FIG. 6), one of the AN 111 and the AN 112 may not support MIMO transmission, while the other may support MIMO transmission. For example, assume the AN 111 supports MIMO transmission, and the AN 112 does not support MIMO transmission. In this case, the first set of numerologies of the AN 111 may include more than one numerology for different codewords, different layers, and/or different links for the first transmission; and the second set of numerologies of the AN 112 may include only one numerology for all codewords, layers, and/or links for the second transmission.

Delay spread for different links may be different, which may result in different minimum requirements of cyclic prefix (CP) length. Furthermore, different types of service may result in different latency. Thus, different numerologies for different codewords, different layers, and/or different links may provide different latencies, allowing flexibility of system design, and improvement of spectrum efficiency and communication reliability.

In some embodiments, the UE 101 may not support frequency division multiplexing (FDM) or spatial division multiplexing (SDM) based multiplexing of multiple numerologies in the same symbol. That is, only time division multiplexing (TDM) based multiplexing of multiple numerologies is supported. Furthermore, the first set of numerologies and second set of numerologies may be different. In this case, the UE 101 may skip processing one of the first transmission and the second transmission that is associated with a particular set of numerologies, based on a selection rule. In some embodiments, the selection rule may include a priority rule or dropping rule, which may be defined to allow the UE 101 to skip decoding of the one of the first transmission and the second transmission that is associated with the particular set of numerologies.

In some embodiments, the selection rule is predefined, e.g, in a related communication standard specification. In some embodiments, the selection rule may be configurable by RRC signaling. The RRC signaling may include at least one of common RRC signaling and dedicated RRC signaling. In some embodiments, the selection rule may be configured via common RRC signaling, for example, NR master information block (NR MIB), NR remaining master information block (NR RMIB), or NR system information block (NR SIB). In some embodiments, the selection rule may be configured via dedicated RRC signaling.

In some embodiments of the disclosure, the one or more numerologies or numerology indicators may be encoded in one DCI, which may be referred to as one-DCI mode. For example, the operations in both of FIG. 3 and FIG. 5 are performed in the one-DCI mode. In some embodiments of the disclosure, the one or more numerologies or numerology indicators may be encoded in two DCI, which may be referred to as two-DCI mode. For example, the operations in both of FIG. 4 and FIG. 6 are performed in the two-DCI mode.

In some embodiments, the NCJT may be operated in the one-DCI mode with a single codeword, and then the DCI may indicate the numerologies for different links/layers. The DCI may include, for example, an indicator to indicate numerology for layer 1 to k, an indicator to indicate numerology for layer k+1 to N, value of k, and value of N. Here N indicates the number of total layers, and k is an integer between 1 and N.

In some embodiments, the NCJT may be operated in the two-DCI mode with two codewords. The DCI may include, for example, an indicator to indicate mapping of a codeword to a layer, an indicator to indicate numerology for a first codeword, and an indicator to indicate numerology for a second codeword.

In some embodiments, the DCI may include a codeword swapping flag to swap mapping of the first codeword to a particular layer into mapping of the second codeword to the particular layer. For example, as the codeword swapping flag, value 0 may indicate no codeword swapping can be used and value 1 may indicate the codeword swapping is enabled, and vice versa.

In some embodiments in which the number of layers is above 4, two codewords may be used for the NCJT, and each codeword may be used for one link In order to allow flexible transmission from the multiple ANs, the codeword to layer mapping scheme may be configurable. Table 1 illustrates an example for the 2-bit indicator to indicate mapping of a codeword to a layer.

TABLE 1
codeword to layer mapping table

| Codeword to | | | | |
|---|---|---|---|---|
| layer mapping | | | | |
| schemes | N = 5 | N = 6 | N = 7 | N = 8 |
| 00 | CW 1 to | CW 1 to | CW 1 to | CW 1 to |
| | layer 1; CW | layer 1; CW | layer 1; CW | layer 1; CW |
| | 2 to layer | 2 to layer | 2 to layer | 2 to layer |
| | 2-5 | 2-6 | 2-7 | 2-8 |
| 01 | CW 1 to | CW 1 to | CW 1 to | CW 1 to |
| | layer 1-2; | layer 1-2; | layer 1-2; | layer 1-2; |
| | CW 2 to | CW 2 to | CW 2 to | CW 2 to |
| | layer 3-5 | layer 3-6 | layer 3-7 | layer 3-8 |
| 10 | — | CW 1 to | CW 1 to | CW 1 to |
| | | layer 1-3; | layer 1-3; | layer 1-3; |
| | | CW 2 to | CW 2 to | CW 2 to |
| | | layer 4-6 | layer 4-7 | layer 4-8 |
| 11 | — | — | — | CW 1 to |
| | | | | layer 1-4; |
| | | | | CW 2 to |
| | | | | layer 5-8 |

The above embodiments describe numerology configuration for NJCT, that is, numerology configuration for data transmission. The concept of configuration of different numerologies for different codewords, different layers, and/or different links and configuration of the same numerology for all codewords, layers and/or links may also be applied for transmission of a control channel. The control channel may include one or both of a downlink control channel and an uplink control channel.

In some embodiments, the AN 111 and the AN 112 may determine one or more numerologies for transmission of a control channel and encode them in the higher layer signaling, e.g., RRC signaling. The downlink control channel is described as an example below.

As mentioned above, the concept of configuration of different numerologies for different codewords, different layers, and/or different links and configuration of the same numerology for all codewords, layers and/or links may also be applied for transmission of a control channel. Therefore, the manner of configuration of the one or more numerologies for the transmission of the downlink control channel may be the same with that for the NCJT.

In particular, the UE 101 may decode the higher layer signaling to determine one or more numerologies, configured by one or both of the AN 111 and the AN 112, for at least one of different codewords, different layers, and different links for transmission of a first downlink control channel from the AN 111 and transmission of a second downlink control channel from the AN 112 to the UE 101. The UE 101 may process the transmission of the first downlink control channel and the transmission of the second downlink control channel according to the determined one or more numerologies for the transmission of the first downlink control channel and the transmission of the second downlink control channel respectively.

In some embodiments, the AN 111 and the AN 112 may coordinate with one another for the one or more numerologies. One of the AN 111 and the AN 112 may configure (e.g., determine, and encode) the one or more numerologies for both of the transmission of the first downlink control channel and the transmission of the second downlink control channel. In an embodiment, for example, the AN 111 may encode the one or more numerologies for both transmissions in the higher layer signaling from the AN 111.

In some embodiments, the AN 111 and the AN 112 may determine and encode the one or more numerologies for the transmission of the first downlink control channel and the transmission of the second downlink control channel independently via respective higher layer signaling.

In the case that different numerologies are configured for at least one of different codewords, different layers, and different links for transmission of the downlink control channels, in some embodiments the numerologies for the transmission of the first downlink control channel may be the same with those for the transmission of the second downlink control channel. In other embodiments, the numerologies for the transmission of the first downlink control channel may be different from those for the transmission of the second downlink control channel.

In the case that the same numerology is configured for all codewords, layers, and/or links for transmission of the downlink control channels, in some embodiments, the AN 111, for example, may coordinate with the AN 112 to keep the same numerology with one another. In some embodiments, the AN 111 and the AN 112 perform numerology configuration independently, and the UE 101 may report the numerology determined from one of the AN 111 and the AN 112 to the other one of the AN 111 and the AN 112 if they respectively configure different numerologies.

In an embodiment, one or more numerologies for the transmission of a control channel may be configured by higher layers in a UE specific manner via RRC signaling. One or more numerologies for transmission of a data channel may be configured by higher layers signaling or dynamically indicated in the DCI. In an embodiment, the same set of one or more numerologies may be applied for the transmission of the control channel and data channel from one AN. In another embodiment, different sets of one or more numerologies may be applied for the transmission of the control channel and data channel from one AN. In other words, the sets of numerologies for the above first transmission, the second transmission, the transmission of the first downlink control channel, and the transmission of the second downlink control channel may be the same or the different from each other. The embodiments of the disclosure are not limited in this respect.

In some embodiments, cross numerology scheduling may be used to schedule the data transmission. For example, a set of one or more numerologies may be employed for the transmission of a control channel and a data channel from an AN, e.g., the AN 111. Further, the set of one or more numerologies may also be used for the transmission of a control channel from another AN, e.g., the AN 112. Another set of one or more numerologies may be employed for the transmission of a data channel from the another AN.

In some embodiments, in addition to the above MIMO layer mapping coordination for NCJT among different beam pair links (BPL), an independent MIMO transmission scheduling for each BPL can be also applied provided that crosstalk-free MIMO channel, i.e., very small or almost no interference among different BPLs, may be experienced. In this case, in addition to the explicit or implicit numerology signaling, the individual DCI or the field thereof associated with each BPL can simply indicate the respective numbers of codewords and scheduled MIMO layers. This would allow NCJT to achieve flexible aggregation of BPLs.

Numerology configuration for transmissions of data channel and control channel are described in details above. The configuration manners may also be applied to transmission scheme for codeword(s), layer(s), and/or link(s). In some embodiments, different transmission schemes may be configured for at least one of different codewords, different layers, and different links. In some embodiments, the same transmission scheme may be configured for all codewords, layers, and/or links. The details for configuration manners of transmission schemes are omitted for conciseness herein. The transmission scheme may include, but not limited to, the above mapping of a codeword to a layer.

In addition, the manners of numerology configuration and transmission scheme configuration above may also be applied for uplink CoMP. The details for numerology configuration and transmission scheme configuration for uplink CoMP are omitted herein for conciseness.

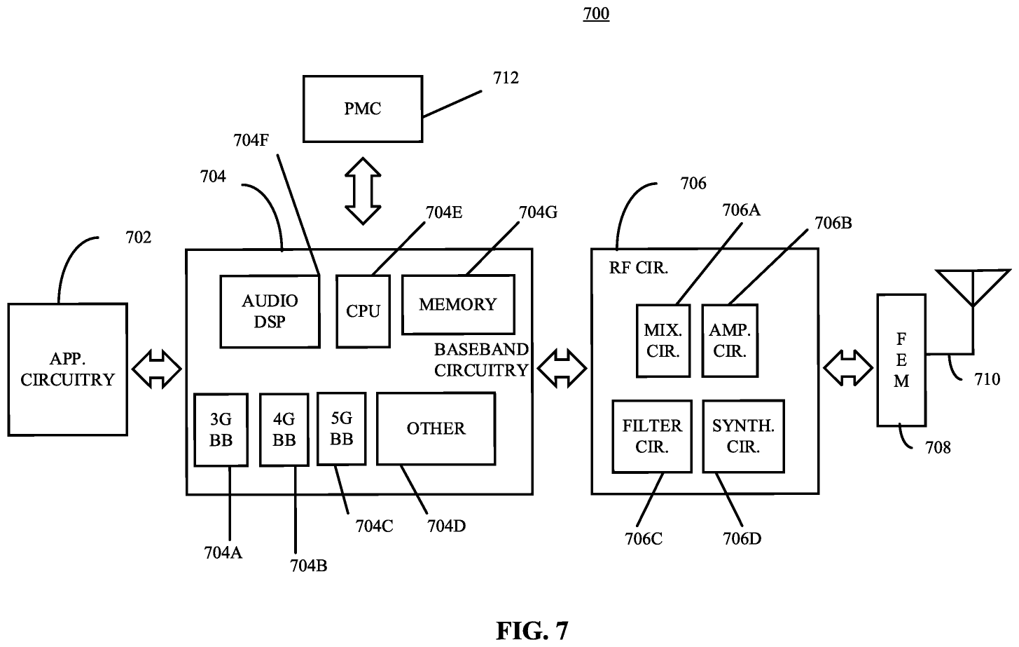

FIG. 7 illustrates example components of a device 700 in accordance with some embodiments. In some embodiments, the device 700 may include application circuitry 702, baseband circuitry 704, Radio Frequency (RF) circuitry 706, front-end module (FEM) circuitry 708, one or more antennas 710, and power management circuitry (PMC) 712 coupled together at least as shown. The components of the illustrated device 700 may be included in a UE or an AN. In some embodiments, the device 700 may include less elements (e.g., an AN may not utilize application circuitry 702, and instead include a processor/controller to process IP data received from an EPC). In some embodiments, the device 700 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 702 may include one or more application processors. For example, the application circuitry 702 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 700. In some embodiments, processors of application circuitry 702 may process IP data packets received from an EPC.

The baseband circuitry 704 may include circuitry such as, but not limited to, one or more single-core or multi-core processors. The baseband circuitry 704 may include one or more baseband processors or control logic to process baseband signals received from a receive signal path of the RF circuitry 706 and to generate baseband signals for a transmit signal path of the RF circuitry 706. Baseband processing circuity 704 may interface with the application circuitry 702 for generation and processing of the baseband signals and for controlling operations of the RF circuitry 706. For example, in some embodiments, the baseband circuitry 704 may include a third generation (3G) baseband processor 704A, a fourth generation (4G) baseband processor 704B, a fifth generation (5G) baseband processor 704C, or other baseband processor(s) 704D for other existing generations, generations in development or to be developed in the future (e.g., second generation (2G), sixth generation (6G), etc.). The baseband circuitry 704 (e.g., one or more of baseband processors 704A-D) may handle various radio control functions that enable communication with one or more radio networks via the RF circuitry 706. In other embodiments, some or all of the functionality of baseband processors 704A-D may be included in modules stored in the memory 704G and executed via a Central Processing Unit (CPU) 704E. The radio control functions may include, but are not limited to, signal modulation/demodulation, encoding/decoding, radio frequency shifting, etc. In some embodiments, modulation/demodulation circuitry of the baseband circuitry 704 may include Fast-Fourier Transform (FFT), precoding, or constellation mapping/demapping functionality. In some embodiments, encoding/decoding circuitry of the baseband circuitry 704 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 704 may include one or more audio digital signal processor(s) (DSP) 704F. The audio DSP(s) 704F may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 704 and the application circuitry 702 may be implemented together such as, for example, on a system on a chip (SOC).

In some embodiments, the baseband circuitry 704 may provide for communication compatible with one or more radio technologies. For example, in some embodiments, the baseband circuitry 704 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 704 is configured to support radio communications of more than one wireless protocol may be referred to as multi-mode baseband circuitry.

RF circuitry 706 may enable communication with wireless networks using modulated electromagnetic radiation through a non-solid medium. In various embodiments, the RF circuitry 706 may include switches, filters, amplifiers, etc. to facilitate the communication with the wireless network. RF circuitry 706 may include a receive signal path which may include circuitry to down-convert RF signals received from the FEM circuitry 708 and provide baseband signals to the baseband circuitry 704. RF circuitry 706 may also include a transmit signal path which may include circuitry to up-convert baseband signals provided by the baseband circuitry 704 and provide RF output signals to the FEM circuitry 708 for transmission.

In some embodiments, the receive signal path of the RF circuitry 706 may include mixer circuitry 706a, amplifier circuitry 706b and filter circuitry 706c. In some embodiments, the transmit signal path of the RF circuitry 706 may include filter circuitry 706c and mixer circuitry 706a. RF circuitry 706 may also include synthesizer circuitry 706d for synthesizing a frequency for use by the mixer circuitry 706a of the receive signal path and the transmit signal path. In some embodiments, the mixer circuitry 706a of the receive signal path may be configured to down-convert RF signals received from the FEM circuitry 708 based on the synthesized frequency provided by synthesizer circuitry 706d. The amplifier circuitry 706b may be configured to amplify the down-converted signals and the filter circuitry 706c may be a low-pass filter (LPF) or band-pass filter (BPF) configured to remove unwanted signals from the down-converted signals to generate output baseband signals. Output baseband signals may be provided to the baseband circuitry 704 for further processing. In some embodiments, the output baseband signals may be zero-frequency baseband signals, although this is not a requirement. In some embodiments, mixer circuitry 706a of the receive signal path may comprise passive mixers, although the scope of the embodiments is not limited in this respect.

In some embodiments, the mixer circuitry 706a of the transmit signal path may be configured to up-convert input baseband signals based on the synthesized frequency provided by the synthesizer circuitry 706d to generate RF output signals for the FEM circuitry 708. The baseband signals may be provided by the baseband circuitry 704 and may be filtered by filter circuitry 706c.

In some embodiments, the mixer circuitry 706a of the receive signal path and the mixer circuitry 706a of the transmit signal path may include two or more mixers and may be arranged for quadrature downconversion and upconversion, respectively. In some embodiments, the mixer circuitry 706a of the receive signal path and the mixer circuitry 706a of the transmit signal path may include two or more mixers and may be arranged for image rejection (e.g., Hartley image rejection). In some embodiments, the mixer circuitry 706a of the receive signal path and the mixer circuitry 706a may be arranged for direct downconversion and direct upconversion, respectively. In some embodiments, the mixer circuitry 706a of the receive signal path and the mixer circuitry 706a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 706 may include analog-to-digital converter (ADC) and digital-to-analog converter (DAC) circuitry and the baseband circuitry 704 may include a digital baseband interface to communicate with the RF circuitry 706.

In some dual-mode embodiments, a separate radio IC circuitry may be provided for processing signals for each spectrum, although the scope of the embodiments is not limited in this respect.

In some embodiments, the synthesizer circuitry 706d may be a fractional-N synthesizer or a fractional N/N+1 synthesizer, although the scope of the embodiments is not limited in this respect as other types of frequency synthesizers may be suitable. For example, synthesizer circuitry 706d may be a delta-sigma synthesizer, a frequency multiplier, or a synthesizer comprising a phase-locked loop with a frequency divider.

The synthesizer circuitry 706d may be configured to synthesize an output frequency for use by the mixer circuitry 706a of the RF circuitry 706 based on a frequency input and a divider control input. In some embodiments, the synthesizer circuitry 706d may be a fractional N/N+1 synthesizer.

In some embodiments, frequency input may be provided by a voltage controlled oscillator (VCO), although that is not a requirement. Divider control input may be provided by either the baseband circuitry 704 or the applications processor 702 depending on the desired output frequency. In some embodiments, a divider control input (e.g., N) may be determined from a look-up table based on a channel indicated by the applications processor 702.

Synthesizer circuitry 706d of the RF circuitry 706 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 706d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 706 may include an IQ/polar converter.

FEM circuitry 708 may include a receive signal path which may include circuitry configured to operate on RF signals received from one or more antennas 710, amplify the received signals and provide the amplified versions of the received signals to the RF circuitry 706 for further processing. FEM circuitry 708 may also include a transmit signal path which may include circuitry configured to amplify signals for transmission provided by the RF circuitry 706 for transmission by one or more of the one or more antennas 710. In various embodiments, the amplification through the transmit or receive signal paths may be done solely in the RF circuitry 706, solely in the FEM 708, or in both the RF circuitry 706 and the FEM 708.

In some embodiments, the FEM circuitry 708 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 706). The transmit signal path of the FEM circuitry 708 may include a power amplifier (PA) to amplify input RF signals (e.g., provided by RF circuitry 706), and one or more filters to generate RF signals for subsequent transmission (e.g., by one or more of the one or more antennas 710).

In some embodiments, the PMC 712 may manage power provided to the baseband circuitry 704. In particular, the PMC 712 may control power-source selection, voltage scaling, battery charging, or DC-to-DC conversion. The PMC 712 may often be included when the device 700 is capable of being powered by a battery, for example, when the device is included in a UE. The PMC 712 may increase the power conversion efficiency while providing desirable implementation size and heat dissipation characteristics.

While FIG. 7 shows the PMC 712 coupled only with the baseband circuitry 704. However, in other embodiments, the PMC 712 may be additionally or alternatively coupled with, and perform similar power management operations for, other components such as, but not limited to, application circuitry 702, RF circuitry 706, or FEM 708.

In some embodiments, the PMC 712 may control, or otherwise be part of, various power saving mechanisms of the device 700. For example, if the device 700 is in an RRC_Connected state, where it is still connected to the RAN node as it expects to receive traffic shortly, then it may enter a state known as Discontinuous Reception Mode (DRX) after a period of inactivity. During this state, the device 700 may power down for brief intervals of time and thus save power.

If there is no data traffic activity for an extended period of time, then the device 700 may transition off to an RRC_Idle state, where it disconnects from the network and does not perform operations such as channel quality feedback, handover, etc. The device 700 goes into a very low power state and it performs paging where again it periodically wakes up to listen to the network and then powers down again. The device 700 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 702 and processors of the baseband circuitry 704 may be used to execute elements of one or more instances of a protocol stack. For example, processors of the baseband circuitry 704, alone or in combination, may be used execute Layer 3, Layer 2, or Layer 1 functionality, while processors of the application circuitry 704 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer. As referred to herein, Layer 2 may comprise a medium access control (MAC) layer, a radio link control (RLC) layer, and a packet data convergence protocol (PDCP) layer. As referred to herein, Layer 1 may comprise a physical (PHY) layer of a UE/RAN node.

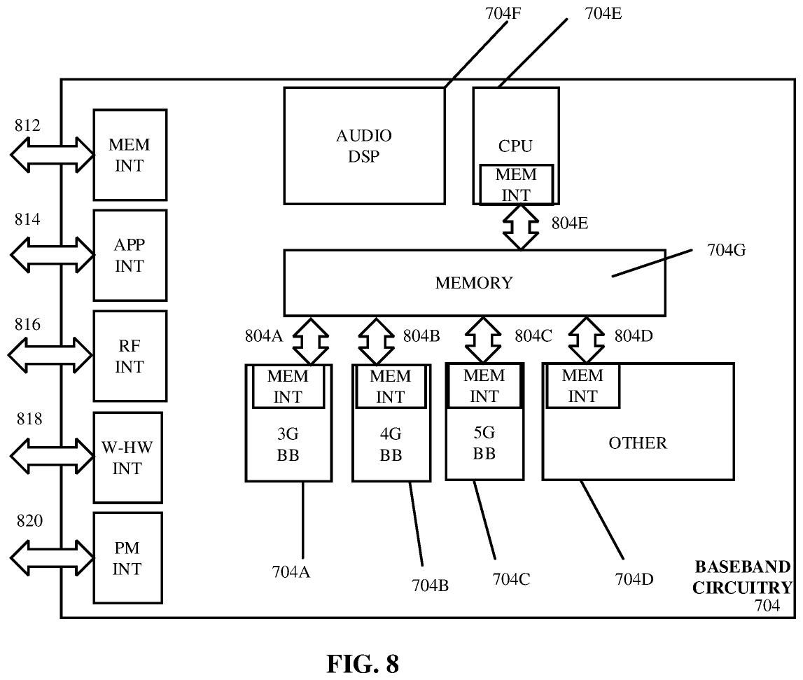

FIG. 8 illustrates example interfaces of baseband circuitry in accordance with some embodiments. As discussed above, the baseband circuitry 704 of FIG. 7 may comprise processors 704A-704E and a memory 704G utilized by said processors. Each of the processors 704A-704E may include a memory interface, 804A-804E, respectively, to send/receive data to/from the memory 704G.

The baseband circuitry 704 may further include one or more interfaces to communicatively couple to other circuitries/devices, such as a memory interface 812 (e.g., an interface to send/receive data to/from memory external to the baseband circuitry 704), an application circuitry interface 814 (e.g., an interface to send/receive data to/from the application circuitry 702 of FIG. 7), an RF circuitry interface 816 (e.g., an interface to send/receive data to/from RF circuitry 706 of FIG. 7), a wireless hardware connectivity interface 818 (e.g., an interface to send/receive data to/from Near Field Communication (NFC) components, Bluetooth® components (e.g., Bluetooth® Low Energy), Wi-Fi® components, and other communication components), and a power management interface 820 (e.g., an interface to send/receive power or control signals to/from the PMC 712.

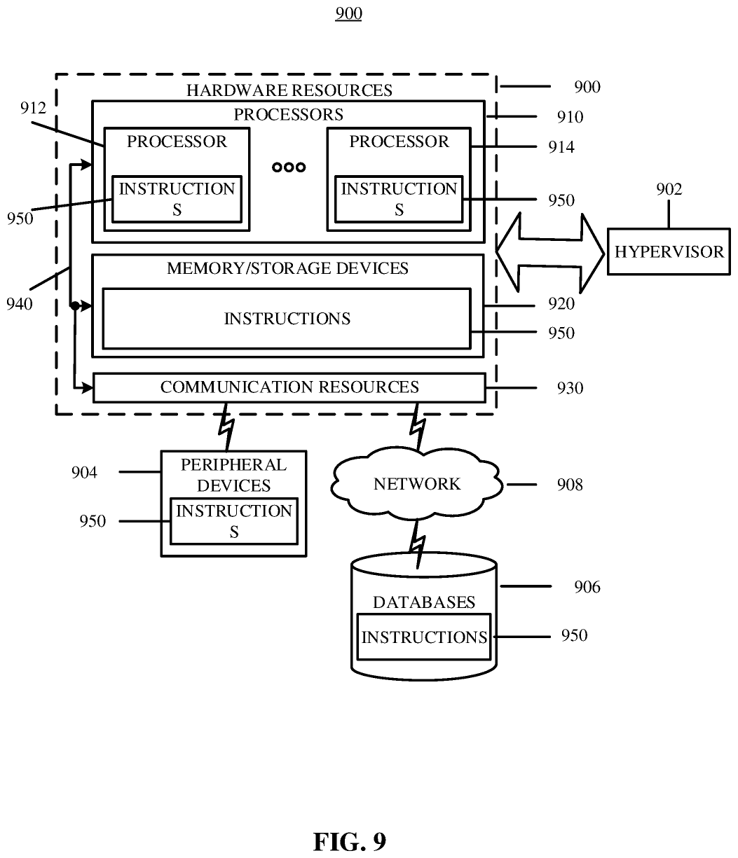

FIG. 9 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940. For embodiments where node virtualization (e.g., NFV) is utilized, a hypervisor 902 may be executed to provide an execution environment for one or more network slices/sub-slices to utilize the hardware resources 900.

The processors 910 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 912 and a processor 914.

The memory/storage devices 920 may include main memory, disk storage, or any suitable combination thereof. The memory/storage devices 920 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 930 may include interconnection or network interface components or other suitable devices to communicate with one or more peripheral devices 904 or one or more databases 906 via a network 908. For example, the communication resources 930 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

The following paragraphs describe examples of various embodiments.

Example 1 includes an apparatus for a user equipment (UE), including circuitry configured to: determine one or more numerologies defined for at least one of different codewords, different layers, and different links for a non-coherent joint transmission (NCJT) to the UE, the NCJT including a first transmission from a first access node and a second transmission from a second access node; and process the NCJT according to the determined one or more numerologies.

Example 2 includes the apparatus of Example 1, wherein the one or more numerologies include more than one numerology, and wherein the circuitry is further configured to decode higher layer signaling or Downlink Control Information (DCI) from the first access node to determine numerologies for the first transmission; and decode higher layer signaling or DCI from the second access node to determine numerologies for the second transmission.

Example 3 includes the apparatus of Example 1, wherein the at least one numerology for the first transmission is the same as the at least one numerology for the second transmission.

Example 4 includes the apparatus of Example 1, wherein the at least one numerology for the first transmission is different from the at least one numerology for the second transmission.

Example 5 includes the apparatus of Example 1, wherein the one or more numerologies include more than one numerology, and wherein the circuitry is further configured to decode higher layer signaling or Downlink Control Information (DCI) from the first access node to determine numerologies for the first transmission and the second transmission respectively.

Example 6 includes the apparatus of Example 1, wherein the one or more numerologies include a single numerology, and wherein the circuitry is further configured to decode higher layer signaling or Downlink Control Information (DCI) from one or both of the first access node and the second access node to determine the numerology.

Example 7 includes the apparatus of any of Examples 1-6, wherein the circuitry is further configured to transmit a report to one or both of the first access node and the second access node to indicate whether the UE supports more than one numerology for the at least one of different codewords, different layers, and different links.

Example 8 includes the apparatus of any of Examples 1-7, wherein the circuitry is further configured to determine one or more numerologies defined for at least one of different codewords, different layers, and different links for transmission of a first downlink control channel from the first access node and transmission of a second downlink control channel from the second access node to the UE.

Example 9 includes the apparatus of Example 8, wherein the circuitry is further configured to process the transmission of the first downlink control channel and the transmission of the second downlink control channel according to the determined one or more numerologies for the transmission of the first downlink control channel and the transmission of the second downlink control channel.

Example 10 includes the apparatus of Example 8 or 9, wherein the one or more numerologies for the transmission of the first downlink control channel and the transmission of the second downlink control channel include more than one numerology, and wherein the circuitry is further configured to decode the higher layer signaling from the first access node to determine numerologies for the transmission of the first downlink control channel; and decode the higher layer signaling from the second access node to determine numerologies for the transmission of the second downlink control channel.

Example 11 includes the apparatus of Example 8 or 9, wherein the at least one numerology for the transmission of the first downlink control channel is the same as the at least one numerology for the transmission of the second downlink control channel.

Example 12 includes the apparatus of Example 8 or 9, wherein the at least one numerology for the transmission of the first downlink control channel is different from the at least one numerology for the transmission of the second downlink control channel.

Example 13 includes the apparatus of Example 8 or 9, wherein the one or more numerologies for the transmission of the first downlink control channel and the transmission of the second downlink control channel include a single numerology, and wherein the circuitry is further configured to decode the higher layer signaling from one of the first access node and the second access node to determine the numerology.

Example 14 includes the apparatus of any of Examples 8-13, wherein the one or more numerologies for the first transmission or the second transmission are the same as those for the transmission of the first downlink control channel or the transmission of the second downlink control channel.

Example 15 includes the apparatus of any of Examples 8-13, wherein the one or more numerologies for the first transmission or the second transmission are different from those for the transmission of the first downlink control channel or the transmission of the second downlink control channel.

Example 16 includes the apparatus of any of Examples 8-15, wherein the circuitry is further configured to skip processing at least one of the transmission of the first downlink control channel, the transmission of the second downlink control channel, the first transmission and the second transmission, which is associated with a particular numerology, based on a selection rule.

Example 17 includes the apparatus of Example 16, wherein the selection rule is predefined or is configurable by radio resource control (RRC) signaling.

Example 18 includes the apparatus of Example 17, wherein the RRC signaling includes at least one of common RRC signaling and dedicated RRC signaling.

Example 19 includes the apparatus of any of Examples 1-18, wherein the one or more numerologies are used for at least one of different layers and different links, wherein a single codeword is used for the NCJT, and wherein Downlink Control Information (DCI) includes an indicator to indicate numerology for layer 1 to k, an indicator to indicate numerology for layer k+1 to N, value of k, and value of N, wherein N indicates the number of total layers, and wherein k is an integer between 1 and N.

Example 20 includes the apparatus of any of Examples 1-18, wherein two codewords are used for the NCJT, and wherein Downlink Control Information (DCI) includes an indicator to indicate mapping of a codeword to a layer, an indicator to indicate numerology for a first codeword, and an indicator to indicate numerology for a second codeword.

Example 21 includes the apparatus of Example 20, wherein the DCI includes a codeword swapping flag to swap mapping of the first codeword to a particular layer into mapping of the second codeword to the particular layer.

Example 22 includes an apparatus for a user equipment (UE), including circuitry configured to: determine one or more transmission schemes defined for at least one of different codewords, different layers, and different links for a non-coherent joint transmission (NCJT) to the UE, the NCJT including a first transmission from a first access node and a second transmission from a second access node; and process the NCJT according to the determined one or more transmission schemes.

Example 23 includes the apparatus of Example 22, wherein the one or more transmission schemes include more than one transmission scheme, and wherein the circuitry is further configured to decode higher layer signaling or Downlink Control Information (DCI) from the first access node to determine transmission schemes for the first transmission; and decode higher layer signaling or DCI from the second access node to determine transmission schemes for the second transmission.

Example 24 includes the apparatus of Example 22, wherein the at least one transmission scheme for the first transmission is the same as the at least one transmission scheme for the second transmission.

Example 25 includes the apparatus of Example 22, wherein the at least one transmission scheme for the first transmission is different from the at least one transmission scheme for the second transmission.

Example 26 includes the apparatus of Example 22, wherein the one or more transmission schemes include more than one transmission scheme, and wherein the circuitry is further configured to decode higher layer signaling or Downlink Control Information (DCI) from the first access node to determine transmission schemes for the first transmission and the second transmission respectively.

Example 27 includes the apparatus of Example 22, wherein the one or more transmission schemes include a single one transmission scheme, and wherein the circuitry is further configured to decode higher layer signaling or Downlink Control Information (DCI) from one or both of the first access node and the second access node to determine the transmission scheme.

Example 28 includes the apparatus of any of Examples 22-27, wherein the circuitry is further configured to transmit a report to one or both of the first access node and the second access node to indicate whether the UE supports more than one transmission scheme for the at least one of different codewords, different layers, and different links.

Example 29 includes an apparatus for an access node, including circuitry configured to: determine one or more numerologies for at least one of different codewords, different layers, and different links for a first transmission from the access node to a user equipment (UE); and encode the first transmission according to the determined one or more numerologies, wherein the first transmission forms a non-coherent joint transmission (NCJT) to the UE along with a second transmission from a second access node.

Example 30 includes the apparatus of Example 29, wherein the one or more numerologies include more than one numerology, and wherein the circuitry is further configured to encode numerologies for the first transmission in higher layer signaling or Downlink Control Information (DCI).

Example 31 includes the apparatus of Example 29, wherein the one or more numerologies include more than one numerology, and wherein the circuitry is further configured to determine numerologies for the first transmission and the second transmission respectively.

Example 32 includes the apparatus of Example 29, wherein the at least one numerology for the first transmission is the same as the at least one numerology for the second transmission.

Example 33 includes the apparatus of Example 29, wherein the at least one numerology for the first transmission is different from the at least one numerology for the second transmission.

Example 34 includes the apparatus of any of Examples 31-33, wherein the circuitry is further configured to indicate the numerologies for the second transmission to the second access node.

Example 35 includes the apparatus of Example 29, wherein the one or more numerologies include a single numerology, and wherein the circuitry is further configured to configure the numerology for the first transmission via higher layer signaling or Downlink Control Information (DCI).

Example 36 includes the apparatus of Example 35, wherein the circuitry is further configured to indicate the numerology for the first transmission to the second access node for the second transmission.

Example 37 includes the apparatus of any of Examples 29-36, wherein the circuitry is further configured to coordinate with a third access node about the one or more numerologies for the UE during handover of the UE from one or more of the first access node and the second access node to the third access node.

Example 38 includes a method performed by a user equipment (UE), including: determining one or more numerologies defined for at least one of different codewords, different layers, and different links for a non-coherent joint transmission (NCJT) to the UE, the NCJT including a first transmission from a first access node and a second transmission from a second access node; and processing the NCJT according to the determined one or more numerologies.

Example 39 includes the method of Example 38, wherein the one or more numerologies include more than one numerology, and wherein the method further includes: decoding higher layer signaling or Downlink Control Information (DCI) from the first access node to determine numerologies for the first transmission; and decoding higher layer signaling or DCI from the second access node to determine numerologies for the second transmission.

Example 40 includes the method of Example 38, wherein the at least one numerology for the first transmission is the same as the at least one numerology for the second transmission.

Example 41 includes the method of Example 38, wherein the at least one numerology for the first transmission is different from the at least one numerology for the second transmission.

Example 42 includes the method of Example 38, wherein the one or more numerologies include more than one numerology, and wherein the method further includes decoding higher layer signaling or Downlink Control Information (DCI) from the first access node to determine numerologies for the first transmission and the second transmission respectively.

Example 43 includes the method of Example 38, wherein the one or more numerologies include a single one numerology, and wherein the method further includes decoding higher layer signaling or Downlink Control Information (DCI) from one or both of the first access node and the second access node to determine the numerology.

Example 44 includes the method of any of Examples 38-43, wherein the method further includes transmitting a report to one or both of the first access node and the second access node to indicate whether the UE supports more than one numerology for the at least one of different codewords, different layers, and different links.

Example 45 includes the method of any of Examples 38-44, wherein the method further includes determining one or more numerologies defined for at least one of different codewords, different layers, and different links for transmission of a first downlink control channel from the first access node and transmission of a second downlink control channel from the second access node to the UE.

Example 46 includes the method of Example 45, wherein the method further includes processing the transmission of the first downlink control channel and the transmission of the second downlink control channel according to the determined one or more numerologies for the transmission of the first downlink control channel and the transmission of the second downlink control channel.

Example 47 includes the method of Example 45 or 46, wherein the one or more numerologies for the transmission of the first downlink control channel and the transmission of the second downlink control channel include more than one numerology, and wherein the method further includes: decoding the higher layer signaling from the first access node to determine numerologies for the transmission of the first downlink control channel; and decoding the higher layer signaling from the second access node to determine numerologies for the transmission of the second downlink control channel.

Example 48 includes the method of Example 45 or 46, wherein the at least one numerology for the transmission of the first downlink control channel is the same as the at least one numerology for the transmission of the second downlink control channel.

Example 49 includes the method of Example 45 or 46, wherein the at least one numerology for the transmission of the first downlink control channel is different from the at least one numerology for the transmission of the second downlink control channel.

Example 50 includes the method of Example 45 or 46, wherein the one or more numerologies for the transmission of the first downlink control channel and the transmission of the second downlink control channel include a single numerology, and wherein the method further includes decoding the higher layer signaling from one of the first access node and the second access node to determine the numerology.

Example 51 includes the method of any of Examples 45-50, wherein the one or more numerologies for the first transmission or the second transmission are the same as those for the transmission of the first downlink control channel or the transmission of the second downlink control channel.

Example 52 includes the method of any of Examples 45-50, wherein the one or more numerologies for the first transmission or the second transmission are different from those for the transmission of the first downlink control channel or the transmission of the second downlink control channel.

Example 53 includes the method of any of Examples 45-52, wherein the method further includes skipping processing at least one of the transmission of the first downlink control channel, the transmission of the second downlink control channel, the first transmission and the second transmission, which is associated with a particular numerology, based on a selection rule.

Example 54 includes the method of Example 53, wherein the selection rule is predefined or is configurable by radio resource control (RRC) signaling.

Example 55 includes the method of Example 54, wherein the RRC signaling includes at least one of common RRC signaling and dedicated RRC signaling.

Example 56 includes the method of any of Examples 38-55, wherein the one or more numerologies are used for at least one of different layers and different links, wherein a single codeword is used for the NCJT, and wherein Downlink Control Information (DCI) includes an indicator to indicate numerology for layer 1 to k, an indicator to indicate numerology for layer k+1 to N, value of k, and value of N, wherein N indicates the number of total layers, and wherein k is an integer between 1 and N.

Example 57 includes the method of any of Examples 38-55, wherein two codewords are used for the NCJT, and wherein Downlink Control Information (DCI) includes an indicator to indicate mapping of a codeword to a layer, an indicator to indicate numerology for a first codeword, and an indicator to indicate numerology for a second codeword.

Example 58 includes the method of Example 57, wherein the DCI includes a codeword swapping flag to swap mapping of the first codeword to a particular layer into mapping of the second codeword to the particular layer.

Example 59 includes a method performed by a user equipment (UE), including: determining one or more transmission schemes defined for at least one of different codewords, different layers, and different links for a non-coherent joint transmission (NCJT) to the UE, the NCJT including a first transmission from a first access node and a second transmission from a second access node; and processing the NCJT according to the determined one or more transmission schemes.

Example 60 includes the method of Example 59, wherein the one or more transmission schemes include more than one transmission scheme, and wherein the method further includes: decoding higher layer signaling or Downlink Control Information (DCI) from the first access node to determine transmission schemes for the first transmission; and decoding higher layer signaling or DCI from the second access node to determine transmission schemes for the second transmission.

Example 61 includes the method of Example 59, wherein the at least one transmission scheme for the first transmission is the same as the at least one transmission scheme for the second transmission.

Example 62 includes the method of Example 59, wherein the at least one transmission scheme for the first transmission is different from the at least one transmission scheme for the second transmission.

Example 63 includes the method of Example 59, wherein the one or more transmission schemes include more than one transmission scheme, and wherein the method further includes decoding higher layer signaling or Downlink Control Information (DCI) from the first access node to determine transmission schemes for the first transmission and the second transmission respectively.

Example 64 includes the method of Example 59, wherein the one or more transmission schemes include a single one transmission scheme, and wherein the method further includes decoding higher layer signaling or Downlink Control Information (DCI) from one or both of the first access node and the second access node to determine the transmission scheme.

Example 65 includes the method of any of Examples 59-64, wherein the method further includes transmitting a report to one or both of the first access node and the second access node to indicate whether the UE supports more than one transmission scheme for the at least one of different codewords, different layers, and different links.

Example 66 includes a method performed by an access node, including: determining one or more numerologies for at least one of different codewords, different layers, and different links for a first transmission from the access node to a user equipment (UE); and encoding the first transmission according to the determined one or more numerologies, wherein the first transmission forms a non-coherent joint transmission (NCJT) to the UE along with a second transmission from a second access node.

Example 67 includes the method of Example 66, wherein the one or more numerologies include more than one numerology, and wherein the method further includes encoding numerologies for the first transmission in higher layer signaling or Downlink Control Information (DCI).

Example 68 includes the method of Example 66, wherein the one or more numerologies include more than one numerology, and wherein the method further includes determining numerologies for the first transmission and the second transmission respectively.

Example 69 includes the method of Example 66, wherein the at least one numerology for the first transmission is the same as the at least one numerology for the second transmission.

Example 70 includes the method of Example 66, wherein the at least one numerology for the first transmission is different from the at least one numerology for the second transmission.

Example 71 includes the method of any of Examples 68-70, wherein the method further includes indicating the numerologies for the second transmission to the second access node.

Example 72 includes the method of Example 66, wherein the one or more numerologies include a single numerology, and wherein the method further includes configuring the numerology for the first transmission via higher layer signaling or Downlink Control Information (DCI).

Example 73 includes the method of Example 72, wherein the method further includes indicating the numerology for the first transmission to the second access node for the second transmission.

Example 74 includes the method of any of Examples 66-73, wherein the method further includes coordinating with a third access node about the one or more numerologies for the UE during handover of the UE from one or more of the first access node and the second access node to the third access node.

Example 75 includes a non-transitory computer-readable medium having instructions stored thereon, the instructions when executed by one or more processor(s) causing the processor(s) to perform the method of any of Examples 38-65.

Example 76 includes a non-transitory computer-readable medium having instructions stored thereon, the instructions when executed by one or more processor(s) causing the processor(s) to perform the method of any of Examples 66-74.

Example 77 includes an apparatus for user equipment (UE), including means for performing the actions of the method of any of Examples 38-58.

Example 78 includes an apparatus for user equipment (UE), including means for performing the actions of the method of any of Examples 59-65.

Example 79 includes an apparatus for an access node (AN), including means for performing the actions of the method of any of Examples 66-74.

Example 80 includes user equipment (UE) as shown and described in the description.

Example 81 includes an access node (AN) as shown and described in the description.

Example 82 includes a method performed at user equipment (UE) as shown and described in the description.

Example 83 includes a method performed at an access node (AN) as shown and described in the description.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the appended claims and the equivalents thereof.

1-25. (canceled)

26. An apparatus for a user equipment (UE), comprising circuitry configured to:
determine one or more numerologies defined for at least one of different codewords, different layers, and different links for a non-coherent joint transmission (NCJT) to the UE, the NCJT comprising a first transmission from a first access node and a second transmission from a second access node; and
process the NCJT according to the determined one or more numerologies.

27. The apparatus of claim 26, wherein the one or more numerologies comprise more than one numerology, and wherein the circuitry is further configured to:
decode higher layer signaling or Downlink Control Information (DCI) from the first access node to determine numerologies for the first transmission; and
decode higher layer signaling or DCI from the second access node to determine numerologies for the second transmission.

28. The apparatus of claim 26, wherein the at least one numerology for the first transmission is the same as the at least one numerology for the second transmission.

29. The apparatus of claim 26, wherein the at least one numerology for the first transmission is different from the at least one numerology for the second transmission.

30. The apparatus of claim 26, wherein the one or more numerologies comprise more than one numerology, and wherein the circuitry is further configured to decode higher layer signaling or Downlink Control Information (DCI) from the first access node to determine numerologies for the first transmission and the second transmission respectively.

31. The apparatus of claim 26, wherein the one or more numerologies comprise a single numerology, and wherein the circuitry is further configured to decode higher layer signaling or Downlink Control Information (DCI) from one or both of the first access node and the second access node to determine the numerology.

32. The apparatus of claim 26, wherein the circuitry is further configured to transmit a report to one or both of the first access node and the second access node to indicate whether the UE supports more than one numerology for the at least one of different codewords, different layers, and different links.

33. The apparatus of claim 26, wherein the circuitry is further configured to determine one or more numerologies defined for at least one of different codewords, different layers, and different links for transmission of a first downlink control channel from the first access node and transmission of a second downlink control channel from the second access node to the UE.

34. 9. The apparatus of claim 33, wherein the one or more numerologies for the transmission of the first downlink control channel and the transmission of the second downlink control channel comprise more than one numerology, and wherein the circuitry is further configured to:
decode the higher layer signaling from the first access node to determine numerologies for the transmission of the first downlink control channel; and
decode the higher layer signaling from the second access node to determine numerologies for the transmission of the second downlink control channel.

35. The apparatus of claim 33, wherein the one or more numerologies for the transmission of the first downlink control channel and the transmission of the second downlink control channel comprise a single numerology, and wherein the circuitry is further configured to decode the higher layer signaling from one of the first access node and the second access node to determine the numerology.

36. The apparatus of claim 33, wherein the one or more numerologies for the first transmission or the second transmission are the same as those for the transmission of the first downlink control channel or the transmission of the second downlink control channel.

37. The apparatus of claim 33, wherein the one or more numerologies for the first transmission or the second transmission are different from those for the transmission of the first downlink control channel or the transmission of the second downlink control channel.

38. The apparatus of claim 33, wherein the circuitry is further configured to skip processing at least one of the transmission of the first downlink control channel, the transmission of the second downlink control channel, the first transmission and the second transmission, which is associated with a particular numerology, based on a selection rule.

39. The apparatus of claim 38, wherein the selection rule is predefined or is configurable by radio resource control (RRC) signaling.

40. The apparatus of claim 26, wherein the one or more numerologies are used for at least one of different layers and different links, wherein a single codeword is used for the NCJT, and wherein Downlink Control Information (DCI) comprises an indicator to indicate numerology for layer 1 to k, an indicator to indicate numerology for layer k+1 to N, value of k, and value of N, wherein N indicates the number of total layers, and wherein k is an integer between 1 and N.

41. The apparatus of claim 26, wherein two codewords are used for the NCJT, and wherein Downlink Control Information (DCI) comprises an indicator to indicate mapping of a codeword to a layer, an indicator to indicate numerology for a first codeword, and an indicator to indicate numerology for a second codeword.

42. The apparatus of claim 41, wherein the DCI comprises a codeword swapping flag to swap mapping of the first codeword to a particular layer into mapping of the second codeword to the particular layer.

43. An apparatus for a user equipment (UE), comprising circuitry configured to:
determine one or more transmission schemes defined for at least one of different codewords, different layers, and different links for a non-coherent joint transmission (NCJT) to the UE, the NCJT comprising a first transmission from a first access node and a second transmission from a second access node; and
process the NCJT according to the determined one or more transmission schemes.

44. The apparatus of claim 43, wherein the one or more transmission schemes comprise more than one transmission scheme, and wherein the circuitry is further configured to:
decode higher layer signaling or Downlink Control Information (DCI) from the first access node to determine transmission schemes for the first transmission; and
decode higher layer signaling or DCI from the second access node to determine transmission schemes for the second transmission.

45. The apparatus of claim 43, wherein the one or more transmission schemes comprise more than one transmission scheme, and wherein the circuitry is further configured to decode higher layer signaling or Downlink Control Information (DCI) from the first access node to determine transmission schemes for the first transmission and the second transmission respectively.

46. The apparatus of claim 43, wherein the one or more transmission schemes comprise a single one transmission scheme, and wherein the circuitry is further configured to decode higher layer signaling or Downlink Control Information (DCI) from one or both of the first access node and the second access node to determine the transmission scheme.

47. The apparatus of claim 43, wherein the circuitry is further configured to transmit a report to one or both of the first access node and the second access node to indicate whether the UE supports more than one transmission scheme for the at least one of different codewords, different layers, and different links.

48. An apparatus for an access node, comprising circuitry configured to:
determine one or more numerologies for at least one of different codewords, different layers, and different links for a first transmission from the access node to a user equipment (UE); and
encode the first transmission according to the determined one or more numerologies,
wherein the first transmission forms a non-coherent joint transmission (NCJT) to the UE along with a second transmission from a second access node.

49. The apparatus of claim 48, wherein the one or more numerologies comprise more than one numerology, and wherein the circuitry is further configured to encode numerologies for the first transmission in higher layer signaling or Downlink Control Information (DCI).

50. The apparatus of claim 48, wherein the one or more numerologies comprise more than one numerology, and wherein the circuitry is further configured to determine numerologies for the first transmission and the second transmission respectively.
